(19) United States
(12) Patent Application Publication
(10) Pub. No.: US 2023/0347299 A1
(43) Pub. Date: Nov. 2, 2023

(54) COMPOSITE FLUOROPOLYMER MEMBRANES HAVING DIFFERENT SURFACE ENERGIES

(71) Applicants: W.L. Gore & Associates Inc., Newark, DE (US); W. L. Gore & Associates GmbH, Putzbrunn (DE)

(72) Inventors: Orlando Collazo, Dover, DE (US); Anita Dutta, Wilmington, DE (US); Lawrence A. Ford, Munch (DE); Jason J. Strid, Elkton, MD (US)

(21) Appl. No.: 18/042,934

(22) PCT Filed: Aug. 25, 2021
(86) PCT No.: PCT/US2021/047519

§ 371 Date: Feb. 24, 2023

Related U.S. Application Data
(60) Provisional application No. 63/070,852, filed on Aug. 27, 2020.

(51) Int. Cl. B01D 69/12; B01D 71/34; B01D 71/36; B01D 69/02; B01D 67/00

(52) U.S. Cl. CPC B01D 69/12; B01D 71/34; B01D 71/36; B01D 69/02; B01D 67/0027; B01D 67/0088; B01D 2325/24; B01D 2325/02; B01D 2325/04

(57) ABSTRACT

Some embodiments of the present disclosure relate to a composite membrane. In some embodiments, the composite membrane comprises a first fluoropolymer membrane and a second fluoropolymer membrane. In some embodiments a difference between a second surface energy of the second fluoropolymer membrane and a first surface energy of the first fluoropolymer membrane is at least 10 mN/m at 20° C. In some embodiments, the composite membrane has a Z strength of at least 5 psi.

### FIELD

The present disclosure relates generally to composite membranes.

### BACKGROUND

Preparing a composite membrane from at least two fluoropolymers can be difficult. There is a need for composite membranes that can be prepared from at least two fluoropolymers with different surface energies without causing processing challenges or impairing mechanical properties.

### SUMMARY

The summary is a high-level overview of various aspects of the invention and introduces some of the concepts that are further detailed in the Detailed Description section below. This summary is not intended to identify key or essential features of the claimed subject matter, nor is it intended to be used in isolation to determine the scope of the claimed subject matter. The subject matter should be understood by reference to the appropriate portions of the entire specification, any or all drawings, and each claim.

Some embodiments of the present disclosure relate to a composite membrane comprising:
a first expanded fluoropolymer membrane having a first surface energy and a first microstructure having first nodes and first fibrils where the first fibrils interconnect the first nodes and first pores are first void spaces between the first nodes and first fibrils;
a second expanded fluoropolymer membrane having a second surface energy and a second microstructure having second nodes and second fibrils where the second nodes interconnect the second nodes and the second pores are second void spaces between the first nodes and second fibrils;
wherein a Z strength of the composite membrane is at least 5 psi;
wherein the second surface energy is greater than the first surface energy, and wherein a difference between the second surface energy and the first surface energy is at least 10 mN/m at 20° C.

Some embodiments of the present disclosure relate to a composite membrane comprising:
a first expanded fluoropolymer membrane having a first surface energy and a first microstructure having first nodes and first fibrils where the first fibrils interconnect the first nodes and first pores are first void spaces between the first nodes and first fibrils;
a second expanded fluoropolymer membrane having a second surface energy and a second microstructure having second nodes and second fibrils where the second nodes interconnect the second nodes and the second pores are second void spaces between the first nodes and second fibrils;
an imbibing polymer, wherein the imbibing polymer is selectively imbibed into the composite membrane in a sufficient amount so as to incorporate the imbibing polymer into the second microstructure;
wherein a Z strength of the composite membrane is at least 5 psi;
wherein the second surface energy is greater than the first surface energy, and wherein a difference between the second surface energy and the first surface energy is at least 10 mN/m at 20° C.

Some embodiments of the present disclosure relate to a method comprising:
layering a first fluoropolymer having a first surface energy and a second fluoropolymer having a second surface energy to form a two-layer structure;
co-expanding the two-layer structure in at least one direction to form a composite membrane having a Z strength of at least 5 psi, wherein the second surface energy of the composite membrane is greater than the first surface energy of the composite membrane, and wherein a difference between the second surface energy and the first surface energy is at least 10 mN/m at 20° C.

Some embodiments of the present disclosure relate to a method comprising:
layering a first fluoropolymer having a first surface energy and a second fluoropolymer having a second surface energy to form a two-layer structure;
co-expanding the two-layer structure in at least one direction to form a composite membrane having a Z strength of at least 5 psi, wherein the second surface energy of the composite membrane is greater than the first surface energy of the composite membrane, and wherein a difference between the second surface energy and the first surface energy is at least 10 mN/m at 20° C.;
imbibing the composite membrane with an imbibing polymer.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the present disclosure.

FIGS. 1A to 1C are scanning electron micrographs (SEMs) of a first non-limiting example of a composite membrane according to the present disclosure. Specifically, FIG. 1A is the surface of the second layer, FIG. 1B is the surface of the first layer and FIG. 1C is a cross-section of the composite.

FIGS. 2A to 2C are SEMs of a second non-limiting example of a composite membrane according to the present disclosure. Specifically, FIG. 2A is the surface of the second layer, 2B is the surface of the first layer and 2C is a cross-section of the composite.

FIGS. 3A to 3C are SEMs of a third non-limiting example of a composite membrane according to the present disclosure. Specifically, 3A is the surface of the second layer, 2B is the surface of the first layer and 3C is a cross-section of the composite.

FIGS. 4A to 4C are SEMs of a fourth non-limiting example of a composite membrane according to the present disclosure. Specifically, 4A is the surface of the second layer, 4B is the surface of the first layer and 4C is a cross-section of the composite.

FIGS. 5A to 5C are SEMs of a fifth non-limiting example of a composite membrane according to the present disclosure. Specifically, 5A is the surface of the second layer, 5B is the surface of the first layer and 5C is a cross-section of the composite.

FIGS. 6A to 6D are SEMs of a sixth non-limiting example of a composite membrane according to the present disclosure. Specifically, 6A is the surface of the second layer, 6B is the surface of the first layer, 6C and 6D are cross-sections of the composite.

FIGS. 7A to 7C are SEMs of a seventh non-limiting example of a composite membrane according to the present disclosure. Specifically, 7A is the surface of the second layer, 7B is the surface of the first layer and 7C is a cross-section of the composite.

FIGS. 8A to 8D are SEMs of an eighth non-limiting example of a composite membrane according to the present disclosure. Specifically, 8A is the surface of the second layer, 8B is the surface of the first layer, 8C and 8D are cross-sections of the composite.

### DETAILED DESCRIPTION

Persons skilled in the art will readily appreciate that various aspects of the present disclosure can be realized by any number of methods and apparatus configured to perform the intended functions.

Some embodiments of the present disclosure relate to a composite membrane. As used herein a “composite membrane” is a unitary membrane having more than one layer, where each layer has distinct attributes.

In some embodiments, a Z strength of the composite membrane is at least 5 psi. In some embodiments, a Z strength of the composite membrane is at least 10 psi. In some embodiments, a Z strength of the composite membrane is at least 25 psi. In some embodiments, a Z strength of the composite membrane is at least 50 psi. In some embodiments, a Z strength of the composite membrane is at least 100 psi.

In some embodiments, the Z strength of the composite membrane is from 5 psi to 450 psi. In some embodiments, the Z strength of the composite membrane is from 10 psi to 450 psi. In some embodiments, the Z strength of the composite membrane is from 25 psi to 450 psi. In some embodiments, the Z strength of the composite membrane is from 50 psi to 450 psi. In some embodiments, the Z strength of the composite membrane is from 100 psi to 450 psi. In some embodiments, the Z strength of the composite membrane is from 200 psi to 450 psi. In some embodiments, the Z strength of the composite membrane is from 300 psi to 450 psi. In some embodiments, the Z strength of the composite membrane is from 300 psi to 400 psi.

In some embodiments, the composite membrane comprises a first expanded fluoropolymer membrane having a first surface energy and a second expanded fluoropolymer membrane having a second surface energy.

In some embodiments, the second surface energy is greater than the first surface energy, such that a difference between the second surface energy and the first surface energy is at least 10 mN/m at 20° C. In some embodiments, the second surface energy is greater than the first surface energy, such that a difference between the second surface energy and the first surface energy is at least 15 mN/m at 20° C. In some embodiments, the second surface energy is greater than the first surface energy, such that a difference between the second surface energy and the first surface energy is at least 20 mN/m at 20° C. In some embodiments, the second surface energy is greater than the first surface energy, such that a difference between the second surface energy and the first surface energy is at least 25 mN/m at 20° C. In some embodiments, the second surface energy is greater than the first surface energy, such that a difference between the second surface energy and the first surface energy is at least 30 mN/m at 20° C. In some embodiments, the second surface energy is greater than the first surface energy, such that a difference between the second surface energy and the first surface energy is at least 35 mN/m at 20° C.

In some embodiments, the second surface energy is greater than the first surface energy, such that a difference between the second surface energy and the first surface energy is from 10 to 40 mN/m at 20° C. In some embodiments, the second surface energy is greater than the first surface energy, such that a difference between the second surface energy and the first surface energy is from 10 to 35 mN/m at 20° C. In some embodiments, the second surface energy is greater than the first surface energy, such that a difference between the second surface energy and the first surface energy is from 10 to 30 mN/m at 20° C. In some embodiments, the second surface energy is greater than the first surface energy, such that a difference between the second surface energy and the first surface energy is from 10 to 25 mN/m at 20° C. In some embodiments, the second surface energy is greater than the first surface energy, such that a difference between the second surface energy and the first surface energy is from 10 to 20 mN/m at 20° C. In some embodiments, the second surface energy is greater than the first surface energy, such that a difference between the second surface energy and the first surface energy is from 15 to 30 mN/m at 20° C. In some embodiments, the second surface energy is greater than the first surface energy, such that a difference between the second surface energy and the first surface energy is from 12 to 25 mN/m at 20° C.

In some embodiments the first expanded fluoropolymer membrane has a first microstructure. In some embodiments, the first microstructure includes first nodes and first fibrils. In some embodiments, the first fibrils interconnect the first nodes. In some embodiments, the first pores are first void spaces between the first nodes and first fibrils.

In some embodiments, the second expanded fluoropolymer membrane has a second microstructure. In some embodiments, the second microstructure has second nodes and second fibrils. In some embodiments, the second nodes interconnect the second nodes. In some embodiments, the second pores are second void spaces between the first nodes and second fibrils.

In some embodiments, the first expanded fluoropolymer membrane has a thickness that is greater than the second expanded porous polymer membrane.

In some embodiments, the second expanded fluoropolymer membrane has a thickness from 0.1 micron to 50 microns. In some embodiments, the second expanded fluoropolymer membrane has a thickness from 0.1 micron to 5 microns. In some embodiments, the second expanded fluoropolymer membrane has a thickness from 0.1 micron to 2 microns. In some embodiments, the second expanded fluoropolymer membrane has a thickness from 0.1 micron to 1 micron. In some embodiments, the second expanded fluoropolymer membrane has a thickness from 0.1 micron to 0.9 microns. In some embodiments, the second expanded fluoropolymer membrane has a thickness from 0.1 micron to 0.8 microns. In some embodiments, the second expanded fluoropolymer membrane has a thickness from 0.1 micron to 0.7 microns. In some embodiments, the second expanded fluoropolymer membrane has a thickness from 0.1 micron to 0.6 microns. In some embodiments, the second expanded fluoropolymer membrane has a thickness from 0.1 micron to 0.5 microns. In some embodiments, the second expanded fluoropolymer membrane has a thickness from 0.1 micron to 0.4 microns. In some embodiments, the second expanded fluoropolymer membrane has a thickness from 0.1 micron to 0.3 microns. In some embodiments, the second expanded fluoropolymer membrane has a thickness from 0.1 micron to 0.2 microns.

In some embodiments, the composite membrane has a thickness from about 2 microns to about 100 microns. In some embodiments, the composite membrane has a thickness from about 2 microns to about 50 microns. In some embodiments, the composite membrane has a thickness from about 2 microns to about 25 microns. In some embodiments, the composite membrane has a thickness from about 2 microns to about 10 microns. In some embodiments, the composite membrane has a thickness from about 2 microns to about 9 microns. In some embodiments, the composite membrane has a thickness from about 2 microns to about 8 microns. In some embodiments, the composite membrane has a thickness from about 2 microns to about 7 microns. In some embodiments, the composite membrane has a thickness from about 2 microns to about 6 microns. In some embodiments, the composite membrane has a thickness from about 2 microns to about 5 microns. In some embodiments, the composite membrane has a thickness from about 2 microns to about 4 microns. In some embodiments, the composite membrane has a thickness from about 2 microns to about 3 microns.

In some embodiments, the first expanded fluoropolymer membrane comprises expanded polytetrafluoroethylene (ePTFE). As used herein, “ePTFE” is meant to include not only expanded polytetrafluoroethylene (ePTFE), ePTFE homopolymer, modified ePTFE such as are described in U.S. Pat. No. 5,708,044 to Branca, U.S. Pat. No. 6,541,589 to Baillie, U.S. Pat. No. 7,531,611 to Sabol et al., expanded modified PTFE, expanded tetrafluoroethylene (TFE) copolymers, and expanded copolymers of PTFE. Expanded polytetrafluoroethylene (ePTFE) membranes prepared in accordance with the methods described in U.S. Pat. No. 7,306,729 to Bacino et al., U.S. Pat. No. 3,953,566 to Gore, U.S. Pat. No. 5,476,589 to Bacino, or U.S. Pat. No. 5,183,545 to Branca et al. may also be used herein.

In some embodiments, the second expanded fluoropolymer membrane comprises expanded porous tetrafluoroethylene-vinylidene fluoride (TFE-VDF) copolymer or expanded ethylene tetrafluoroethylene (ETFE). In some embodiments, the second expanded fluoropolymer membrane comprises any copolymer from U.S. Pat. No. 8,637,144 to Ford or any copolymer described in U.S. Pat. No. 9,139,669 to Xu et al.

In some embodiments, the composite membrane has a porosity from about 10% to about 98%. In some embodiments, the composite membrane has a porosity from about 25% to about 98%. In some embodiments, the composite membrane has a porosity from about 50% to about 98%. In some embodiments, the composite membrane has a porosity from about 75% to about 98%. In some embodiments, the composite membrane has a porosity from about 10% to about 75%. In some embodiments, the composite membrane has a porosity from about 10% to about 50%. In some embodiments, the composite membrane has a porosity from about 10% to about 25%. In some embodiments, the composite membrane has a porosity from about 25% to about 75%. In some embodiments, the composite membrane has a porosity from about 25% to about 50%.

In some embodiments, the composite membrane has a bubble point from about 0.2 psi to about 150 psi. In some embodiments, the composite membrane has a bubble point from about 1 psi to about 150 psi. In some embodiments, the composite membrane has a bubble point from about 5 psi to about 150 psi. In some embodiments, the composite membrane has a bubble point from about 25 psi to about 150 psi. In some embodiments, the composite membrane has a bubble point from about 50 psi to about 150 psi. In some embodiments, the composite membrane has a bubble point from about 100 psi to about 150 psi. In some embodiments, the composite membrane has a bubble point from about 0.2 psi to about 100 psi. In some embodiments, the composite membrane has a bubble point from about 0.2 psi to about 50 psi. In some embodiments, the composite membrane has a bubble point from about 0.2 psi to about 25 psi. In some embodiments, the composite membrane has a bubble point from about 0.2 psi to about 5 psi. In some embodiments, the composite membrane has a bubble point from about 0.2 psi to about 1 psi. In some embodiments, the composite membrane has a bubble point from about 1 psi to about 100 psi. In some embodiments, the composite membrane has a bubble point from about 5 psi to about 50 psi. In some embodiments, the composite membrane has a bubble point from about 25 psi to about 50 psi.

In some embodiments, the composite membrane has an airflow of about 1 l/h to about 5000 l/h. In some embodiments, the composite membrane has an airflow of about 100 l/h to about 5000 l/h. In some embodiments, the composite membrane has an airflow of about 500 l/h to about 5000 l/h. In some embodiments, the composite membrane has an airflow of about 1000 l/h to about 5000 l/h. In some embodiments, the composite membrane has an airflow of about 1 l/h to about 1000 l/h. In some embodiments, the composite membrane has an airflow of about 1 l/h to about 500 l/h. In some embodiments, the composite membrane has an airflow of about 1 l/h to about 100 l/h. In some embodiments, the composite membrane has an airflow of about 1 l/h to about 50 l/h. In some embodiments, the composite membrane has an airflow of about 100 l/h to about 1000 l/h. In some embodiments, the composite membrane has an airflow of about 500 l/h to about 1000 l/h.

In some embodiments, the composite membrane further comprises an imbibing polymer. In some embodiments, the imbibing polymer is selectively imbibed into the composite membrane. As used herein, “selectively imbibed” or “selective imbibing” means that the imbibing polymer is not incorporated in equal relative quantities into the first and second expanded fluoropolymer membrane. For instance, in some embodiments, the imbibing polymer is incorporated into the second expanded fluoropolymer membrane in a first amount that exceeds a second amount in which the imbibing polymer is incorporated into the first expanded fluoropolymer membrane. In some embodiments, the imbibing polymer is only incorporated into the second expanded fluoropolymer membrane and not the first expanded fluoropolymer membrane. In some embodiments, the selective imbibing is driven by the difference in surface energies between the second expanded fluoropolymer membrane and the first expanded fluoropolymer membrane.

In some embodiments, the imbibing polymer is present in the composite membrane in a sufficient amount so as to incorporate the imbibing polymer into the second microstructure of the second expanded fluoropolymer membrane. For instance, in some embodiments, the second nodes and the second fibrils of the second microstructure may be at least partially coated with the imbibing polymer. As used herein, “at least partially coated” means that at least a portion of one second node and at least a portion of at least one second fibril of the second microstructure is coated with the imbibing polymer. In addition, in some embodiments, the second pores of the second microstructure are at least partially filled by the imbibing polymer. As used herein, “at least partially filled,” means that at least one second pore of the second microstructure is filled with the imbibing polymer. In addition, in some embodiments, the second pores of the second microstructure are completely filled by the imbibing polymer. As used herein “completely filled” means that all or substantially all of the of the second pores of the of the second microstructure are filled with the imbibing polymer. Several non-limiting methods can be used to determine whether the second pores of the second microstructure are completely filled by the imbibing polymer. For example, in some embodiments, the second pores of the second microstructure are completely filled by the imbibing polymer when the composite membrane has an air flow of zero l/h as measured herein. In some embodiments, the second pores of the second microstructure are completely filled by the imbibing polymer when the composite membrane has a porosity of 0%.

In some embodiments, the imbibing polymer includes tetrafluoroethylene-hexafluoropropylene-vinylidene fluoride copolymer (THV), polyvinylidene fluoride (PVDF), polyether imide (PEI), polyimide (PI), polyethersulfone (PESU), Polybenzimidazole (PBI), polyarylates, polyamideimide (PAI), or any combination thereof. In some embodiments, the imbibing polymer comprises at least one functional active ingredient. In some embodiments, the additional functional active ingredient can be nanoparticles, inorganic catalysts, enzymes, absorbents, colorants or any combination thereof. In some embodiments, the additional functional active ingredient can be selected based on a functional property provided by the functional active ingredient, such as but not limited to, thermal conductivity, thermal insulation, electrical conductivity, electrical insulation, catalytic activity, pigmentation, hydrophilicity, hydrophobicity, or any combination thereof.

In some embodiments, the composite membrane does not comprise an adhesive.

In some embodiments, the composite membrane described herein may be formed by the following steps: layering a first polymer having a first surface energy and a second polymer having a second surface energy to form a two-layer structure and co-expanding the two-layer structure in at least one direction to form the composite membrane. A non-limiting example of a co-expansion method is described in U.S. Pat. No. 9,573,339 to Hodgins et. al.

In some embodiments, the method comprises hydrophilizing the second fluoropolymer prior to layering, so as to increase the surface energy of the second fluoropolymer. Non-limiting examples of hydrophilization methods are described in U.S. Pat. No. 5,130,024 to Fujimoto, U.S. Pat. No. 5,354,587 to Abayasekhara, and U.S. Pat. No. 9,139,669 to Xu et al.

In some embodiments, the method comprises drying the two-layer structure prior to co-expanding.

In some embodiments, the co-expansion occurs at a temperature from 130° C. to 400° C. In some embodiments, the co-expansion occurs at a temperature from 200° C. to 400° C. In some embodiments, the co-expansion occurs at a temperature from 300° C. to 400° C. In some embodiments, the co-expansion occurs at a temperature from 130° C. to 300° C. In some embodiments, the co-expansion occurs at a temperature from 130° C. to 200° C. In some embodiments, the co-expansion occurs at a temperature from 200° C. to 400° C. In some embodiments, the co-expansion occurs at a temperature from 300° C. to 400° C.

In some embodiments, the method further comprises imbibing the composite membrane with an imbibing polymer. In some embodiments, the imbibing is selective imbibing. In some embodiments, the imbibing or selective imbibing comprises at least partially coating nodes and fibrils of the composite membrane with the imbibing polymer. In some embodiments, the imbibing or selective imbibing comprises at least partially filling pores of the composite membrane with the imbibing polymer. In some embodiments, the imbibing or selective imbibing comprises completely filling the pores of the composite membrane with the imbibing polymer. When the imbibing is selective imbibing, the imbibing material may be included only in certain portions of the composite membrane, such as but not limited to only the second expanded fluoropolymer membrane as described herein.

In some embodiments, the imbibing may be performed by imbibing techniques, such as, but not limited to, slot die coating, Mayer bar coating, dip coating, roll coating, or any combination thereof. Additional examples of imbibing techniques are described in U.S. Pat. No. 10,647,882 to Dutta et al.

Test Methods

Z-Strength The cohesive strength of the sample composite membranes was measured under ambient conditions using a TAPPI-541 (Zwick, Germany) device. A 3 in×5 in piece of two-sided adhesive tape, such as 9500PC (3M Corporation), was attached to similar sized face of the bottom platen. A sample of the composite or of the membrane, with its machine direction oriented in the long direction of the platen, was placed over the tape covered bottom platen. The membrane in between each of the five 1 in×1 in test areas was slit with a scalpel to isolate the test samples. The upper platen, which has identical five 1 in×1 in test areas, was covered with the same two-sided adhesive tape. The upper & bottom platens were mounted in an Instron tensile testing machine (Model 5567) with the two platens aligned at a 90-degree angle to each other. The platens with the sample in between were compressed together to 170 lbf at a rate of 0.5 in/min and held under that force for 30 seconds. The compressive force was then reduced to zero at a rate of 3000 lbf/min. After 7.5 seconds of force removal, the platens were separated at the rate of 19.7 in/min and the maximum force, in Newtons, to separate the platen was recorded. If the failure is cohesive in nature, the failed sample would be covering the surfaces of both the platens. If the cohesive strength of the sample is greater than the adhesive strength of the tape to the platens or of the tape to the sample, both the platens will not be covered with failed portion of both the samples. Samples in each of the 5 test areas were measured as above and F_{avg}, the average of five maximum force values, is calculated. The Z-strength of the sample in psi (F_{avg} is lbf)/(in²)

Bubble Point The bubble point was measured according to the general teachings of ASTM F316-03 using a Capillary Flow Porometer (Model 3Gzh from Quantachrome Instruments). The sample holder comprised a porous metal plate (Part Number: 04150-10030-25, Quantachrome Instruments), 25.4 mm in diameter and a plastic mask (Part Number ABF-300, Professional Plastics), 20 mm I.D. ×24.5 mm O.D. in diameter. The sample was placed in between the metal plate and the plastic mask. The sample was then clamped down and sealed using an o-ring (Part Number: 51000-25002000, Quantachrome Instruments). The sample was wet with the test fluid (Silicone fluid having a surface tension of 20.1 dynes/cm). Using the 3G Win software version 2.1, the following parameters were set as specified in Tables 1 and 2 below.

TABLE 1

| Run Setting | Pore Size Start | Pore Size End | Pore Size Start | Pore Size End |
|---|---|---|---|---|
| BP range | Pressure (psi) | Pressure (psi) | Size (micron) | Size (micron) |
| BP_9-50 psi | 8.97 | 50.48 | 1.3 | 0.231 |
| BP_50-150 psi | 50.7 | 149.1 | 0.23 | 0.0782 |
| BP_50-120 psi | 50.7 | 120 | 0.23 | 0.0972 |

TABLE 2

| Parameter | Bubble Point |
|---|---|
| Run Type | Wet Only |
| Number Data Points | 256 |
| Pressure Control | |
| Use Normal Equilibrium | TRUE |
| Use Tol | FALSE |
| Use Time | FALSE |
| Use Rate | FALSE |
| Use Low Flow Sensor | FALSE |
| Time Out | NA |
| Equil Time | NA |
| Run Rate | NA |
| Pressure Tolerance | NA |
| Flow Tolerance | NA |
| Smoothing | |
| UseMovAve | FALSE |
| MovAveWet Interval | NA |
| MovAveDry Interval | NA |
| Lowess Dry | 0.050 |
| Lowess Wet | 0.050 |
| Lowess Flow | 0.050 |
| Lowess Num | 0.100 |
| MinSize Threshold | 0.98 |
| Bubble Point Parameters | |
| UseBpAuto | TRUE |
| UseBpThreshold (L/min) | FALSE |
| UseBpThreshold (Abs/cm²) | FALSE |
| UseBpThresholdNumber | FALSE |
| BpAutoTolerance (manual) | 1% |
| BpThresholdValue (manual) | NA |
| BpThreshold (Abs/cm²) value | 0 |

Airflow: The airflow test measures laminar volumetric flow rates of air through membrane samples. Each membrane sample was clamped between two plates in a manner that seals an area of 2.99 cm² across the flow pathway. An ATEQ® (ATEQ Corp., Livonia, MI) Premier D Compact Flow Tester was used to measure airflow rate (L/hr) through each membrane sample by challenging it with a differential air pressure of 1.2 kPa (12 mbar) through the membrane.

### EXAMPLE 1

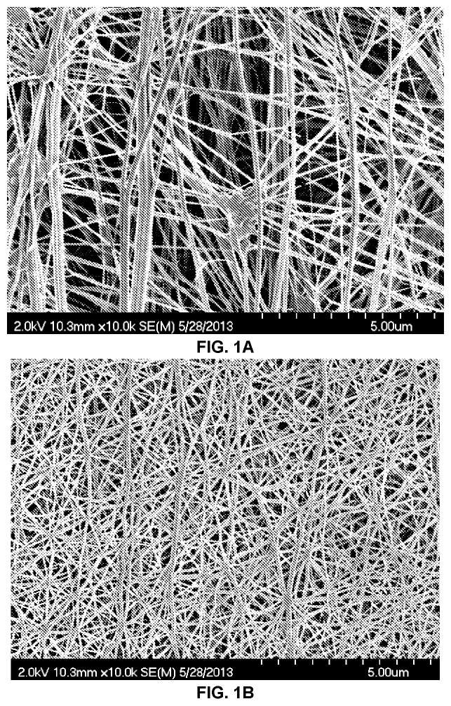

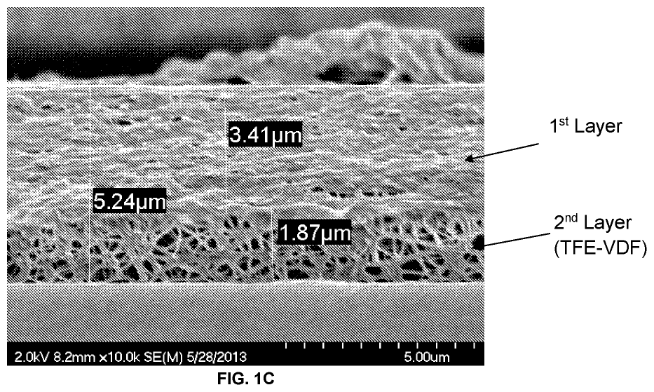

Example 1 is a non-limiting example of a composite membrane having. Scanning electron micrographs (SEMs) of Example 1 are shown in FIGS. 1A to 1C.

Fine powder of PTFE polymer as described and taught in U.S. Pat. No. 6,541,589 was blended with Isopar K (Exxon Mobil Corp., Fairfax, VA) in the proportion of 0.217 g/g of fine powder. The lubricated powder was compressed into a cylinder to form a pellet and placed into an oven set at 49° C. for approximately 12 hours. The compressed and heated pellet was ram extruded to produce a tape approximately 0.71 mm thick. The extruded tape was then rolled down between compression rolls to a thickness of 0.61 mm to produce a first layer.

Fine powder of a polymer, which in the present non-limiting example was TFE-VDF as described and taught in U.S. Pat. No. 9,650,479, was blended with Isopar K (Exxon Mobil Corp., Fairfax, VA) in the proportion of 0.301 g/g of fine powder. The lubricated powder was compressed into a cylinder to form a pellet and placed into an oven set at 49° C. for approximately 12 hours. The compressed and heated pellet was ram extruded to produce a tape approximately 0.69 mm thick. The extruded tape was then rolled down between compression rolls to a thickness of 0.269 mm and then again to a thickness of 0.152 mm to produce the second layer.

The first layer and second layer were then rolled down together between compression rolls to a thickness of 0.711 mm. The tape was transversely stretched to a ratio of ˜5:1 and dried at a temperature of 150° C. The dried tape was longitudinally expanded between banks of rolls over a heated plate set to a temperature of 320° C. The speed ratio between the second bank of rolls and the first bank of rolls was 14:1. The longitudinally expanded tape was then expanded transversely at a temperature of approximately 300° C. to a ratio of 7.4:1 and then restrained and heated in an oven set at 380° C. The aforementioned steps produced a two-layer composite membrane with a mass/area of ˜3.5 g/m², a bubble point of 72.5 psi and an airflow of 30.2 l/hr at 12 mbar for a 2.99 cm² cross-sectional area. SEMs of the two-layer composite membrane are shown in FIGS. 1A to 1C. Other relevant properties are listed below in Table 3.

### EXAMPLE 2

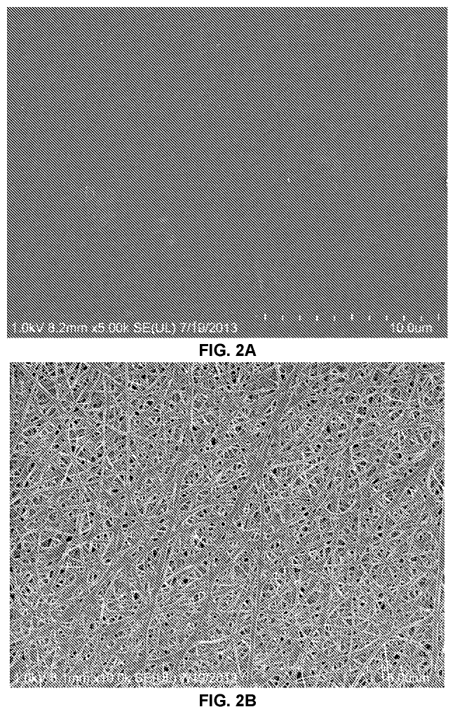

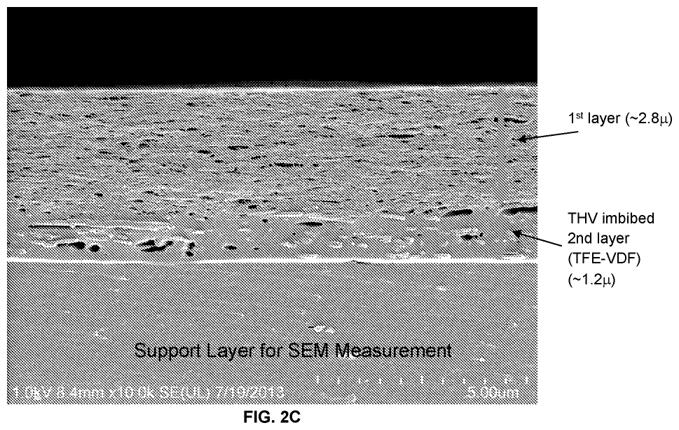

Using a slot die with 3 mil opening, wet film of 5% weight % THV 221 (Dyneon) in DMAc was cast onto a carrier film (3 mil thick BOPP/PET/BOPP from Neptco,) at a line speed of 10 ft/min. At the same line speed, the membrane of Example 1 was placed onto the wet film with the second (TFE-VDF) layer facing the wet film. This allowed the THV solution to imbibe within the second layer to form an imbibed composite membrane. The imbibed composite membrane was then dried by running it through an inline convection oven set at 355° F. (179° C.). The resulting imbibed composite membrane upon removal from the carrier film weighed about 7.6 g/m² SEMs of the imbibed composite membrane are shown in FIGS. 2A to 2C and illustrate the THV polymer to be selectively imbibed within the second layer. Other relevant properties of this imbibed composite membrane are listed in Table 4.

### EXAMPLE 3

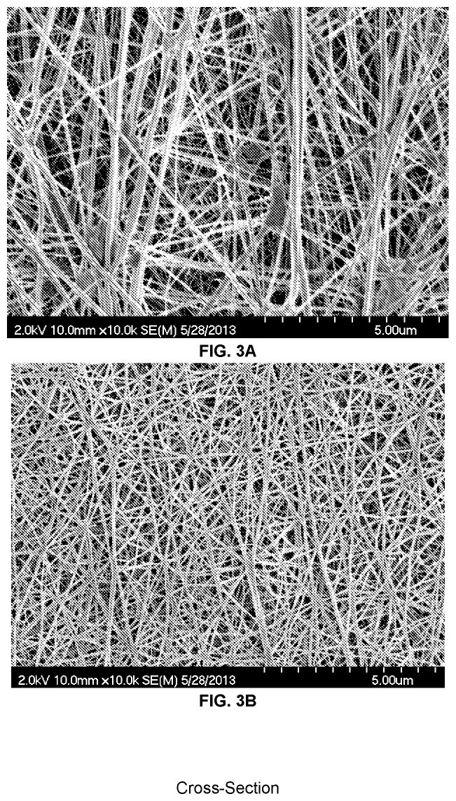

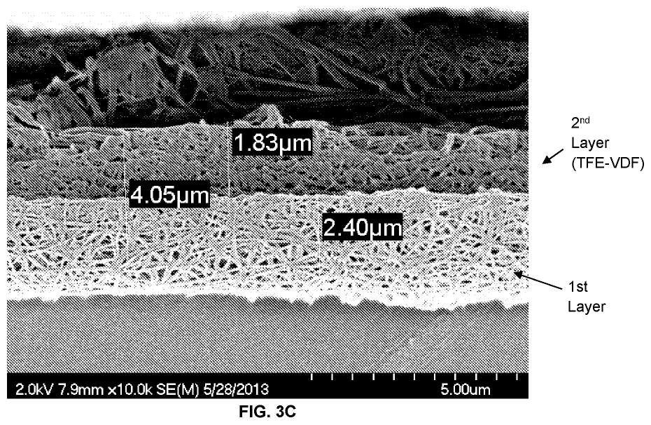

Example 2 relates to a non-limiting example of a composite membrane of example 3. Scanning electron micrographs (SEMs) of example 3 are shown in FIGS. 3A to 3C.

Fine powder of PTFE polymer as described and taught in U.S. Pat. No. 6,541,589 was blended with Isopar K (Exxon Mobil Corp., Fairfax, VA) in the proportion of 0.217 g/g of fine powder. The lubricated powder was compressed into a cylinder to form a pellet and placed into an oven set at 49° C. for approximately 12 hours. The compressed and heated pellet was ram extruded to produce a tape 0.71 mm thick. The extruded tape was then rolled down between compression rolls to a thickness of 0.61 mm to produce the first layer.

Fine powder of the polymer as described and taught in U.S. Pat. No. 9,650,479, which in the present non-limiting example was TFE-VDF, was blended with lsopar K (Down Mobil Corp., Fairfax, VA) in the proportion of 0.301 g/g of fine powder. The lubricated powder was compressed into a cylinder to form a pellet and placed into an oven set at 49° C. for approximately 12 hours. The compressed and heated pellet was ram extruded to produce a tape 0.69 mm thick. The extruded tape was then rolled down between compression rolls to a thickness of 0.269 mm and then again to a thickness of 0.152 mm to produce the second layer.

The first layer and the second layer were then rolled down together between compression rolls to a thickness of 0.711 mm. The tape was then transversely stretched to a ratio of ˜5:1 and then dried at a temperature of 150° C. The dry tape was longitudinally expanded between banks of rolls over a heated plate set to a temperature of 320° C. The speed ratio between the second bank of rolls and the first bank of rolls was 21:1. The longitudinally expanded tape was then expanded transversely at a temperature of approximately 300° C. to a ratio of 8.4:1 and then restrained and heated in an oven set at 380° C. These produced a two-layer composite membrane with a mass/area of ˜1.7 g/m², a bubble point of 74.1 psi and an airflow of 50.3 l/hr at 12 mbar for a 2.99 cm² cross-sectional area and a z-strength values of 42.1, 44.1, 46.2, 45.1 and 42.8 psi for an average of 44.04 psi. The SEMs are shown in FIGS. 3A to 3C and other composite membrane properties are listed in Table 3.

### EXAMPLE 4

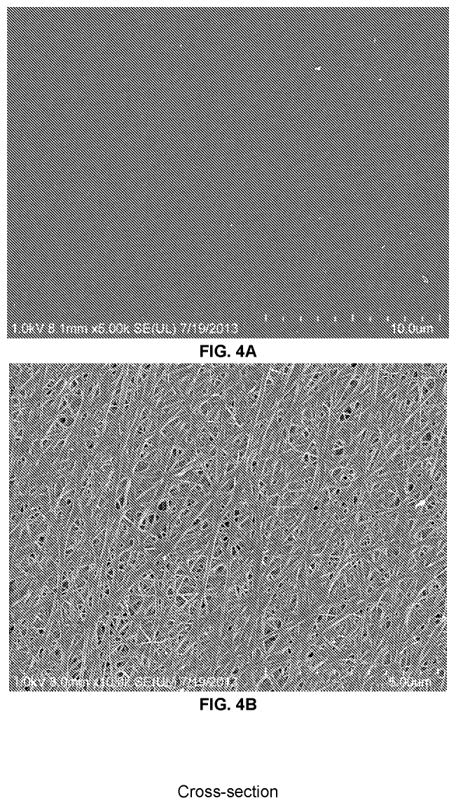

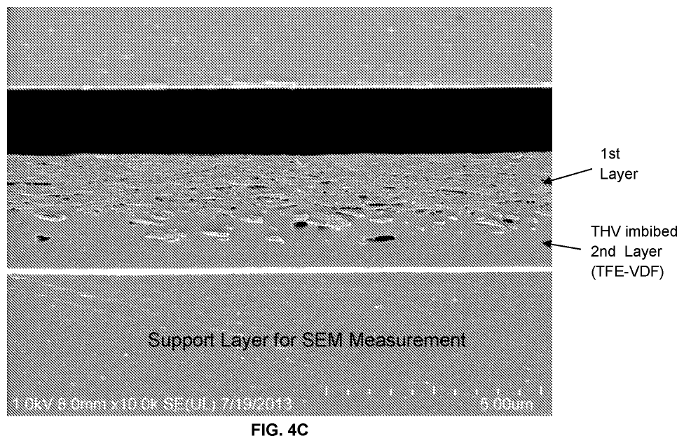

Using a slot die with 3 mil opening, wet film of 5% weight % THV 221 (Dyneon) in DMAc was cast onto a carrier film (3 mil thick BOPP/PET/BOPP from Neptco) at a line speed of 10 ft/min. At the same line speed, the composite membrane from Example 3 was placed onto the wet film with the second layer facing the wet film. This allowed the THV solution to imbibe within the second layer thereby forming an imbibed composite membrane. The imbibed composite membrane was then dried by running the imbibed composite membrane through an inline convection oven set at 355° F. (179° C.). The resulting composite membrane upon removal from the carrier film weighed about 5.8 g/m² and the associated SEMs are shown in FIGS. 4A to 4C. These SEMs show that the THV polymer is selectively imbibed within the second layer. Other relevant properties of this imbibed composite membrane are shown in Table 4.

### EXAMPLE 5

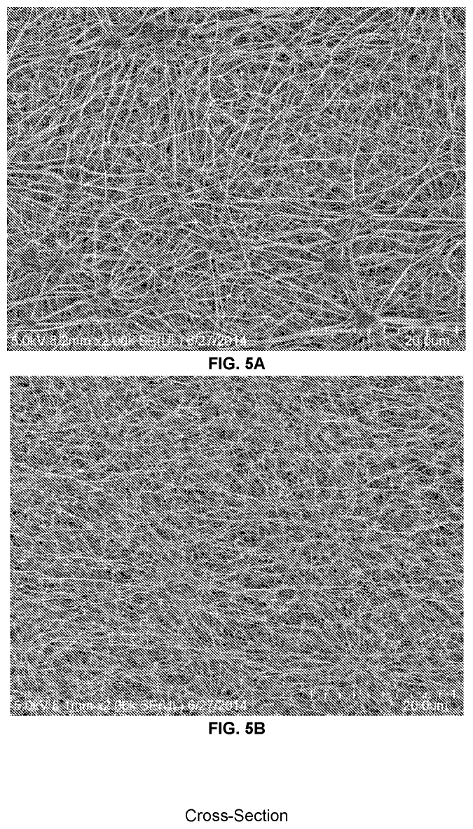

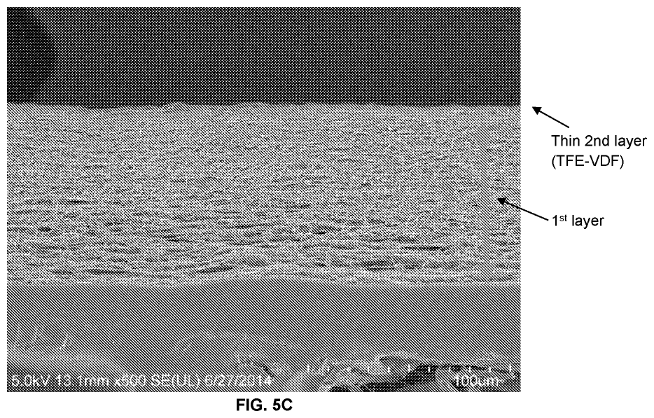

Example 5 relates to a composite membrane, SEMs of which are shown in FIGS. 5A to 5C.

Fine powder of PTFE polymer (DuPont, Parkersbury, WV) was blended with Isopar K (Exxon Mobil Corp., Fairfax, VA) in the proportion of 0.218 g/g of fine powder. The lubricated powder was compressed into a cylinder to form a pellet and conditioned at 23° C. The compressed and heated pellet was ram extruded to produce a tape approximately 1.37 mm thick. The extruded tape was then rolled down between compression rolls to a thickness of 1.27 mm to produce a first layer.

Fine powder of the polymer as described and taught in U.S. Pat. No. 9,650,479, which in the present non-limiting example was TFE-VDF, was blended with Isopar K (Exxon Mobil Corp., Fairfax, VA) in the proportion of 0.301 g/g of fine powder. The lubricated powder was compressed into a cylinder to form a pellet and placed into an oven set at 49° C. for approximately 12 hours. The compressed and heated pellet was ram extruded to produce a tape approximately 0.79 mm thick. The extruded tape was then rolled down between compression rolls to a thickness of 0.254 mm and then again to a thickness of 0.152 mm. The tape was then transversely stretched at a ratio of ˜4.5:1 and dried at 150° C. The tape was transversely stretched at 300° C. by a ratio of ˜2.2:1 to produce the second layer.

The first layer and the second layer were rolled down together between compression rolls to a thickness of 1.27 mm, removing any excess material from the second layer's width, so to match the width of the first layer. The material was then dried at a temperature of 150° C. The dry tape was longitudinally expanded between banks of rolls over a heated plate set to a temperature of 320° C. The speed ratio between the second bank of rolls and the first bank of rolls was 11:1. The longitudinally expanded tape was then expanded transversely at a temperature of approximately 300° C. to a ratio of 19.4:1 and then restrained and heated in an oven set at 380° C. This produced a composite membrane with a mass/area of ˜13.1 g/m² and an airflow of 41.6 l/hr at 12 mbar for a 2.99 cm² cross-sectional area. SEMs are in FIGS. 5A to 5C and other relevant composite membrane properties are shown in Table 4.

### EXAMPLE 6

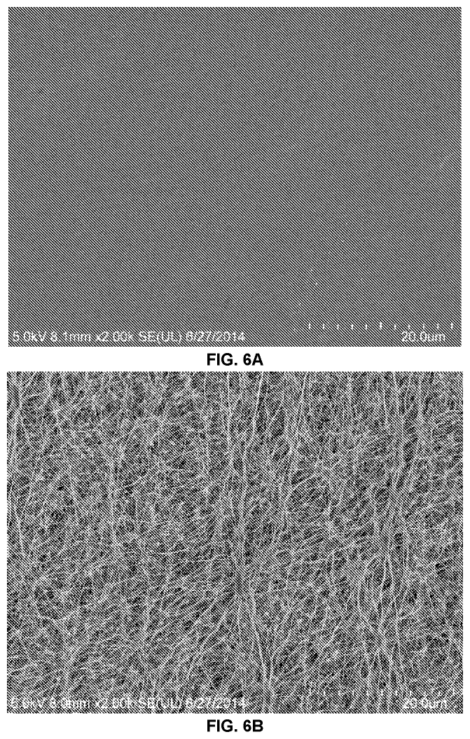

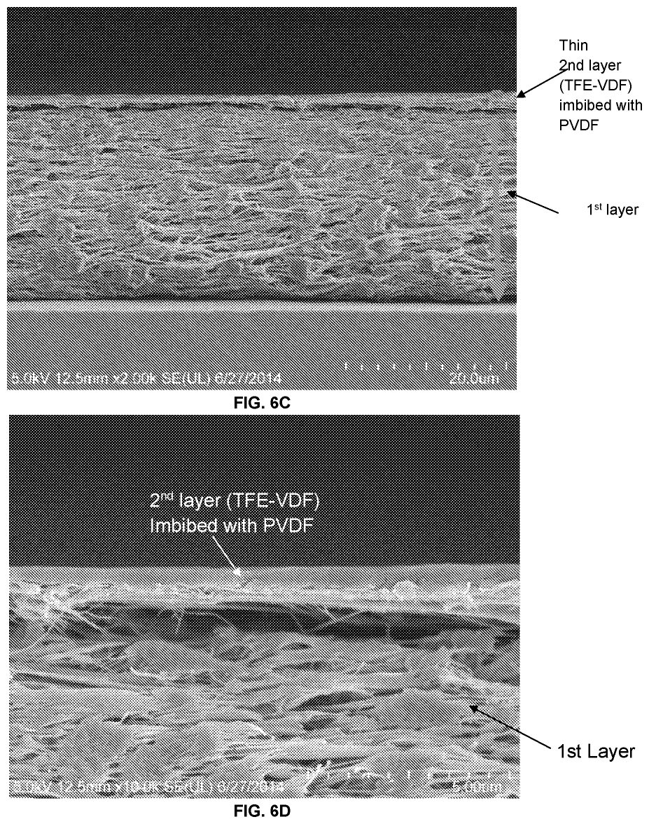

Using a slot die with 2 mil opening, wet film of 5% weight % PVDF (Kynar 710 from Arkema -) in DMAc was cast onto a carrier film (3 mil thick COC from Ajedium, Newark, DE) at a line speed of 8 ft/min. At the same line speed, the composite membrane from example 5 was placed onto the wet film with the second layer facing the wet film. This allowed the PVDF solution to imbibe within the second layer, thereby forming an imbibed composite membrane. The imbibed composite membrane was dried by running the imbibed composite membrane through an inline convection oven set at 270° F. (132° C.). The resulting composite membrane upon removal from the carrier film weighed about 15.9 g/m² and the associated SEMs are shown in FIGS. 6A to 6D. These SEMs show that the PVDF polymer is selectively imbibed within the second layer. Other relevant properties of this imbibed composite membrane are summarized in Table 4.

### EXAMPLE 7

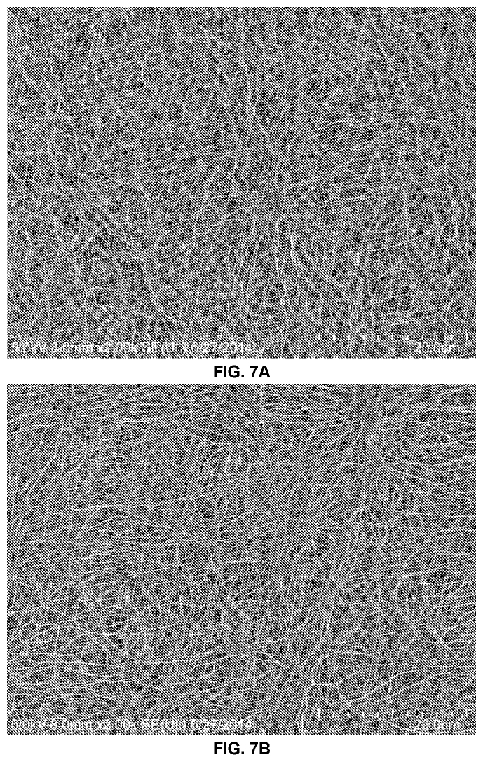

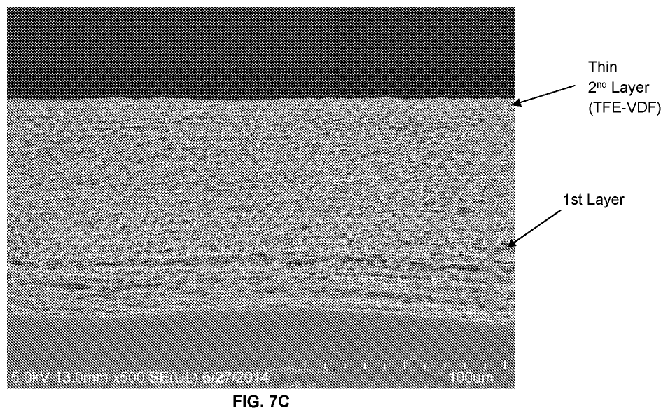

Example 7 relates to a non-limiting example of a composite membrane having example 7. Scanning electron micrographs (SEMs) of example 7 are shown in FIGS. 7A to 7C.

Fine powder of PTFE polymer (DuPont, Parkersbury, VW) was blended with Isopar K (Exxon Mobil Corp., Fairfax, VA) in the proportion of 0.218 g/g of fine powder. The lubricated powder was compressed into a cylinder to form a pellet and conditioned at 23° C. The compressed and heated pellet was ram extruded to produce a tape approximately 1.37 mm thick. The extruded tape was then rolled down between compression rolls to a thickness of 1.27 mm to produce a first layer.

Fine powder of the polymer as described and taught in U.S. Pat. No. 9,650,479, which in the present non-limiting embodiment was TFE-VDF, was blended with Isopar K (Exxon Mobil Corp., Fairfax, VA) in the proportion of 0.268 g/g of fine powder. The lubricated powder was compressed into a cylinder to form a pellet and placed into an oven set at 49° C. for approximately 12 hours. The compressed and heated pellet was ram extruded to produce a tape approximately 0.79 mm thick. The extruded tape was then rolled down between compression rolls to a thickness of 0.254 mm and then again to a thickness of 0.152 mm. The extruded tape was then rolled down between compression rolls to a thickness of 0.254 mm and then again to a thickness of 0.152 mm. The resulting rolled extruded tape was then transversely stretched at a ratio of ˜4.5:1 and dried at 150° C. Finally, the resulting dried rolled extruded tape was transversely stretched at 300° C. by a ratio of ˜2.2:1 to produce a second layer.

The first layer and the second layer were then rolled down together between compression rolls to a thickness of 1.27 mm, removing any excess material from the second layer's width, so to match the width of the first layer. The material was then dried at a temperature of 150° C. The dry tape was longitudinally expanded between banks of rolls over a heated plate set to a temperature of 320° C. The speed ratio between the second bank of rolls and the first bank of rolls was 11:1. The longitudinally expanded tape was then expanded transversely at a temperature of approximately 300° C. to a ratio of 19.4:1 and then restrained and heated in an oven set at 380° C. This produced a composite membrane with a mass/area of ˜13.4 g/m² and an airflow of 40.6 l/hr at 12 mbar for a 2.99 cm² cross-sectional area. SEMs of the composite membrane are in FIGS. 7A to 7C and other relevant properties are in Table 3.

### EXAMPLE 8

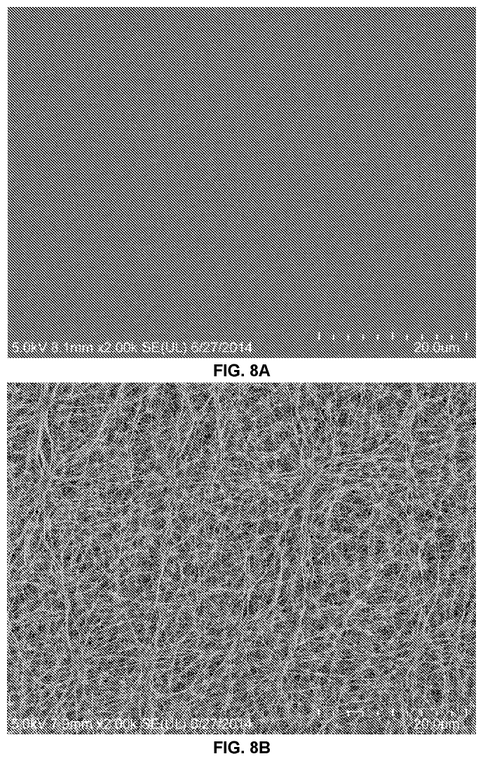

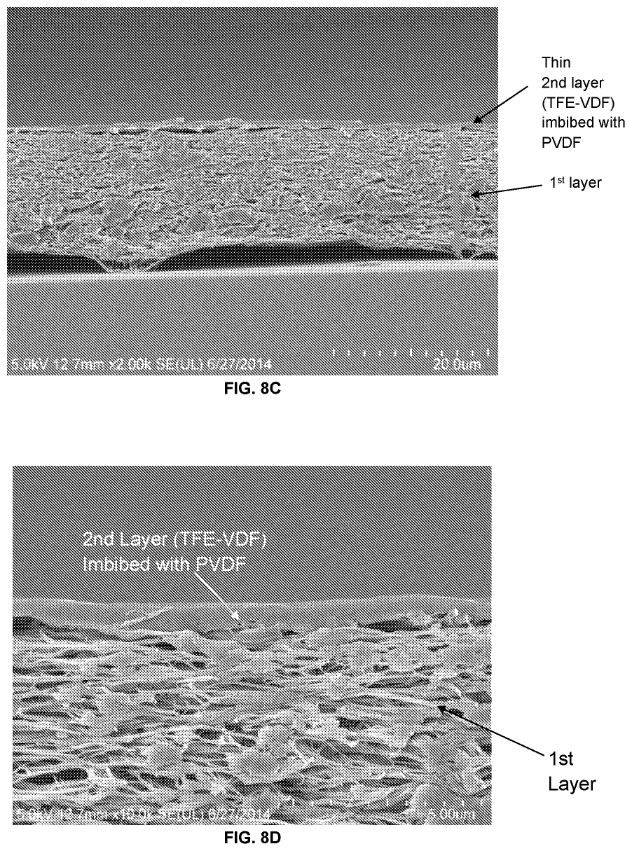

Using a slot die with 2 mil opening, wet film of 5% weight % PVDF (Kynar 710 from Arkema in DMAc was cast onto a carrier film 3 mil thick COC from Ajedium, Newark, DE) at a line speed of 15 ft/min. At the same line speed, the composite membrane from example 7 was placed onto the wet film with the second layer facing the wet film. This allowed the PVDF solution to imbibe within the second layer, thereby forming an imbibed composite membrane. The entire imbibed composite membrane was then dried by running the imbibed composite membrane through an Inline convection oven set at 270° F. (132° C.). The resulting composite membrane upon removal from the carrier film weighed about 15.6 g/m² and the associated SEMs are shown in FIGS. 8A to 8D. These SEMs illustrate that the PVDF polymer is selectively imbibed within the second layer. Other relevant properties of this imbibed composite membrane are listed in Table 4.

Determination of surface Energies of Examples 1-8: The surface energy of each side of the sample composite membranes was determined by applying test fluids of differing surface energies to each surface. The surface energies of the test fluids ranged from 30 to 72 mN/m and were obtained from Diversified Enterprises, Claremont, NH. The sample composite membranes were constrained within a frame to hold the sample composite membranes in place. The tip of a cotton swab was wet with the test fluid. Using the cotton swab, the test fluid was spread over the sample membrane surfaces using as little applied pressure as possible. The test fluid was applied in one long swath.

The applied test fluid was observed for beading from the edge to the center of the applied area for 2 seconds. The test fluid is considered to wet the surface if the film of the test fluid does not bead up. A series of test fluids were applied in this way.

The surface energy of the membrane is determined by the lowest energy test fluid that does not bead up. The surface energy of the membrane is equivalent to the surface energy of the test fluid.

Results and various exemplary properties of the sample composite membranes are shown below in Tables 3 and 4.

TABLE 3

| Example | 1 | 3 | 5 | 7 |
|---|---|---|---|---|
| Composite Mass/area | 3.5 | 1.7 | 13.1 | 13.4 |
| (g/m²) | | | | |
| Composite Airflow | 30.2 | 50.3 | 41.6 | 40.6 |
| (l/hr@12 mbar, 2.99 cm²) | | | | |
| Composite Bubble point | 67.9 | 69 | 19.5 | 23 |
| (psi) | | | | |
| Composite Thickness | 5.24 | 4.05 | 87.5 | 87.5 |
| (microns) | | | | |
| Composite Bulk | 70 | 81 | 93 | 93 |
| Porosity (%) | | | | |
| first layer mass/area | 2.8 | 1.36 | 12.94 | 13.24 |
| (g/m²) | | | | |
| second layer mass/area | 0.7 | 0.34 | 0.16 | 0.16 |
| (g/m²) | | | | |
| first layer thickness | 3.41 | 2.4 | 85 | 85 |
| (micron) | | | | |
| second layer thickness | 1.87 | 1.83 | 2.5 | 2.5 |
| (micron) | | | | |
| first layer porosity (%) | 63 | 74 | 93 | 93 |
| second layer porosity | 83 | 92 | 97 | 97 |
| (%) | | | | |
| Surface energy of first | <30 | <30 | 32 | 34 |
| side (mN/m) | | | | |
| Surface energy of | 45 | 45 | 46 | 46 |
| second side (mN/m) | | | | |

TABLE 4

| | | Composite Airflow | Composite | first layer | second layer | | |
|---|---|---|---|---|---|---|---|
| | Composite Mass/ | (l/hr@12 mbar, | Thickness | thickness | thickness | first layer | second layer |
| Example | area (g/m²) | 2.99 cm²) | (microns) | (micron) | (micron) | porosity (%) | porosity (%) |
| 2 | 7.6 | 0 | 4 | 2.8 | 1.2 | 55 | 0 |
| 4 | 5.8 | 0 | 2.65 | 1.4 | 1.25 | 56 | 0 |
| 6 | 15.9 | 0 | 26.5 | 26 | 0.5 | 77 | 0 |
| 8 | 15.6 | 0 | 15.5 | 15 | 0.5 | 60 | 0 |

1. A composite membrane comprising:
a first expanded fluoropolymer membrane having a first surface energy and a first microstructure having first nodes and first fibrils,
wherein the first fibrils interconnect the first nodes, and
wherein first pores are first void spaces between the first nodes and the first fibrils;
a second expanded fluoropolymer membrane having a second surface energy and a second microstructure having second nodes and second fibrils,
wherein the second nodes interconnect the second nodes, and
wherein second pores are second void spaces between the first nodes and the second fibrils;
wherein a Z strength of the composite membrane is at least 5 psi;
wherein the second surface energy is greater than the first surface energy, and
wherein a difference between the second surface energy and the first surface energy is at least 10 mN/m at 20° C.

2. The composite membrane of claim 1, having a porosity from about 10% to 98%.

3. The composite membrane of claim 1, having a bubble point from 0.2 psi to 150 psi.

4. The composite membrane of claim 1, having an airflow from 1 l/h to 5000 l/h.

5. The composite membrane of claim 1, wherein the second expanded fluoropolymer membrane has a thickness from 0.1 micron to 50 microns.

6. The composite membrane of claim 1, wherein the first expanded fluoropolymer membrane has a thickness that is greater than the second expanded fluoropolymer membrane.

7. The composite membrane of claim 1, wherein the first expanded fluoropolymer membrane comprises expanded polytetrafluoroethylene (ePTFE).

8. The composite membrane of claim 1, wherein the second expanded fluoropolymer membrane comprises expanded porous tetrafluoroethylene-vinylidene fluoride (TFE-VDF) copolymer or expanded ethylene tetrafluoroethylene (ETFE).

9. (canceled)

10. The composite membrane of claim 1, wherein the Z strength of the composite membrane is from 5 psi to 450 psi.

11. (canceled)

12. A composite membrane comprising:
a first expanded fluoropolymer membrane having a first surface energy and a first microstructure having first nodes and first fibrils,
wherein the first fibrils interconnect the first nodes, and
wherein first pores are first void spaces between the first nodes and the first fibrils;
a second expanded fluoropolymer membrane having a second surface energy and a second microstructure having second nodes and second fibrils,
wherein the second nodes interconnect the second nodes, and
wherein second pores are second void spaces between the first nodes and the second fibrils; and
an imbibing polymer,
wherein the imbibing polymer is selectively imbibed into the composite membrane in a sufficient amount so as to incorporate the imbibing polymer into the second microstructure;
wherein a Z strength of the composite membrane is at least 5 psi;
wherein the second surface energy is greater than the first surface energy, and
wherein a difference between the second surface energy and the first surface energy is at least 10 mN/m at 20° C.

13. The composite membrane of claim 12, wherein the second nodes and the second fibrils of the second microstructure are at least partially coated with the imbibing polymer.

14. The composite membrane of claim 12, having a bubble point from 0.2 psi to 150 psi.

15. The composite membrane of claim 12, having an airflow from 1 l/h to 5000 l/h.

16. The composite membrane of claim 12, wherein the second pores of the second microstructure are at least partially filled with the imbibing polymer.

17. The composite membrane of claim 16, wherein the second pores of the second microstructure are at least partially filled with the imbibing polymer, such that the second expanded fluoropolymer membrane has a porosity of 0%.

18. (canceled)

19. The composite membrane of claim 16, wherein the second pores of the second microstructure are at least partially filled with the imbibing polymer, such that the second expanded fluoropolymer membrane has an air flow of zero l/h.

20. (canceled)

21. The composite membrane of claim 12, wherein the first expanded fluoropolymer membrane has a thickness that is greater than the second expanded fluoropolymer membrane.

22. The composite membrane of claim 12, wherein the first expanded fluoropolymer membrane comprises expanded polytetrafluoroethylene (ePTFE).

23. The composite membrane of claim 12, wherein the second expanded fluoropolymer membrane comprises expanded porous Tetrafluoroethylene-Vinylidene Fluoride (TFE-VDF) copolymer or expanded ethylene tetrafluoroethylene (ETFE).

24. The composite membrane of claim 12, wherein the imbibing polymer comprises tetrafluoroethylene-hexafluoropropylene-vinylidene fluoride copolymer (THV), polyvinylidene fluoride (PVDF), polyether imide (PEI), polyimide (PI), polyethersulfone (PESU), Polybenzimidazole (PBI), polyarylates, polyamideimide (PAI), or any combination thereof.

25. (canceled)

26. (canceled)

27. (canceled)

28. (canceled)

29. (canceled)

30. (canceled)

31. (canceled)

32. (canceled)

33. (canceled)

34. (canceled)

35. (canceled)
